(19) United States
(12) Patent Application Publication
(10) Pub. No.: US 2015/0116148 A1
(43) Pub. Date: Apr. 30, 2015

(54) METHOD FOR PREDICTING SPOOFING SIGNAL AND APPARATUS THEREOF

(71) Applicant: Electronics and Telecommunications Research Institute, Daejeon (KR)

(72) Inventors: Tae hee KIM, Daejeon (KR); Sang Uk LEE, Daejeon (KR); Jae Hoon KIM, Daejeon (KR)

(21) Appl. No.: 14/302,711

(22) Filed: Jun. 12, 2014

(30) Foreign Application Priority Data
Oct. 31, 2013 (KR) 10-2013-0131549

(51) Int. Cl. G01S 19/21

(52) U.S. Cl. CPC G01S 19/215
USPC 342/357.59

(57) ABSTRACT

In a global navigation satellite system, a spoofing signal received at a first point in time is processed to generate measurement data including a carrier phase value, and characteristics of a spoofing signal corresponding to a second point in time at which an anti-spoofing signal is to be generated are predicted on the basis of the measurement data at the first point in time. An anti-spoofing signal is generated on the basis of the predicted characteristics of the spoofing signal.

### CROSS-REFERENCE TO RELATED APPLICATION

This application claims priority to and the benefit of Korean Patent Application No. 10-2013-0131549 filed in the Korean Intellectual Property Office on Oct. 31, 2013, the entire contents of which are incorporated herein by reference.

### BACKGROUND OF THE INVENTION

(a) Field of the Invention

The present disclosure relates to a method for predicting a spoofing signal in a global navigation satellite system (GNSS), and an apparatus thereof.

(b) Description of the Related Art

Recently, the global navigation satellite system (GNSS) using a global positioning system (GPS) has been used in all industrial fields, and as the GNSS is frequently utilized, a malicious intention for disturbing the corresponding system has also been generated.

A spoofing signal is a signal providing false information to a receiver, which manipulates a measurement value and data and provides the same to a receiver such that the receiver generates a navigation solution, without recognizing such spoofing information, to generate a different location, rather than an actual location. Thus, a technique that may cope with a spoofing signal is required, and a technique that cancels out a spoofing signal by generating an anti-spoofing signal has been researched as one of countermeasure techniques.

A spoofer that provides a spoofing signal may manipulate a code and a carrier frequency to change a measurement value in order to spoof a target receiver. In order to cancel such a spoofing signal, an anti-spoofing signal should be generated by accurately tracing and predicting the code and the carrier frequency of the spoofing signal.

However, there may be a difference between a point in time at which a spoofing signal is processed to extract a parameter of the corresponding signal and a point in time at which an anti-spoofing signal is generated by using the extracted parameter. This is because the point in time at which information of the spoofing signal is processed is a past point in time, ahead of the point in time at which the new anti-spoofing signal is generated.

Thus, since the anti-spoofing signal with respect to the spoofing signal used in the future is generated on the basis of information measured in the past, the spoofing signal cannot be effectively cancelled out.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present disclosure has been made in an effort to provide a method for accurately predicting a spoofing signal corresponding to a point in time at which an anti-spoofing signal for removing the spoofing signal is to be generated, and an apparatus thereof.

An exemplary embodiment of the present disclosure provides a method for predicting a spoofing signal, including: generating measurement data including a carrier phase value of a spoofing signal at a first point in time; predicting characteristics of a spoofing signal corresponding to a second point in time at which an anti-spoofing signal is to be generated, on the basis of the measurement data at the first point in time, the characteristics including a carrier phase prediction value; and generating an anti-spoofing signal on the basis of the predicted characteristics of the spoofing signal, wherein the second point in time comes after the first point in time.

The method may further include verifying the predicted characteristics of the spoofing signal, wherein, in the generating of the anti-spoofing signal, the anti-spoofing signal may be generated after the predicted characteristics of the spoofing signal are verified.

The verifying may include: obtaining measurement data including a carrier phase value with respect to the spoofing signal received at the second point in time; obtaining a difference value between the carrier phase prediction value at the second point in time and the carrier phase value at the second point in time; and when the difference value is smaller than a pre-set allowable threshold value, verifying that the predicted characteristics of the spoofing signal has been normally predicted.

The generating of the anti-spoofing signal may include: when the difference value is smaller than the pre-set allowable threshold value, predicting characteristics of the spoofing signal corresponding to a third point in time on the basis of the measurement data at the second point in time; and generating an anti-spoofing signal on the basis of the predicted characteristics of the spoofing signal at the third point in time, wherein the third point in time comes after the second point in time.

The measurement data may further include a Doppler frequency with respect to the spoofing signal. The predicting may include: generating a Doppler prediction value corresponding to the second point in time on the basis of the Doppler frequency of the measurement data; and generating a carrier phase prediction value at the second point in time on the basis of the measurement data at the first point in time and the Doppler prediction value.

The method may further include obtaining navigation data including satellite ephemeris information from the spoofing signal at the first point in time, wherein the generating of the Doppler prediction value may include: calculating a Doppler frequency at the first point in time and a Doppler frequency at the second point in time on the basis of the navigation data, respectively;

determining a Doppler offset on the basis of the calculated Doppler frequency at the first point in time and the Doppler frequency of the measurement data obtained at the first point in time; and generating a Doppler prediction value corresponding to the second point in time on the basis of the Doppler offset and the calculated Doppler frequency at the second point in time.

The generating of the carrier phase prediction value may include: calculating a total number of samples to be generated in an overall prediction time duration; accumulating carrier increment values at sample reflection time intervals by the total number of samples to calculate a final phase value in the overall prediction time duration; and adding the final phase value and the carrier phase value included in the measurement data at the first point in time to generate the carrier phase prediction value.

The carrier increment value may include a carrier increment value at the first point in time calculated on the basis of the Doppler frequency of the measurement data obtained at the first point in time and a carrier increment value at the second point in time calculated on the basis of the calculated Doppler frequency at the second point in time.

The calculating of the total number of samples may include: calculating a sample reflection time duration in which a single carrier increment value is maintained; and calculating a total number of samples on the basis of the number of samples to be reflected in the sample reflection time duration and the number of samples for reflecting the carrier increment values at the first and second points in time.

Another embodiment of the present disclosure provides an apparatus for predicting a spoofing signal in a navigation system, including: a spoofing signal reception processing unit configured to detect a spoofing signal from a received signal, and generate measurement data including a carrier phase value of the spoofing signal at a first point in time; a spoofing signal predicting unit configured to predict characteristics of a spoofing signal corresponding to a second point in time at which an anti-spoofing signal is to be generated, on the basis of the measurement data at the first point in time, the characteristics including a carrier phase prediction value; and an anti-spoofing signal generating unit configured to generate an anti-spoofing signal on the basis of the predicted characteristics of the spoofing signal.

The spoofing signal reception processing unit may include: a signal tracking unit configured to trace the detected spoofing signal to generate measurement values related to a code and a carrier, and generate bit information; a code phase measurement data generating unit configured to perform code tracking on the measurement values to generate a code phase value corresponding to the first point in time; a carrier phase measurement data generating unit configured to process the measurement values to generate a carrier phase value corresponding to the first point in time; a Doppler measurement data generating unit configured to perform a frequency tracking loop on the basis of a signal output from the signal tracking unit to generate a Doppler frequency corresponding to the first point in time; and a navigation data generating unit configured to generate navigation data including satellite ephemeris information on the basis of the bit information.

The spoofing signal predicting unit may include: a measurement data collecting unit configured to collect measurement data including the code phase value, the carrier phase value, and the Doppler frequency corresponding to the first point in time output from the spoofing signal reception processing unit; a navigation data collecting unit configured to collect navigation data output from the spoofing signal reception processing unit; a Doppler predicting unit configured to generate a Doppler prediction value corresponding to the second point in time on the basis of the Doppler frequency of the measurement data; and a carrier phase predicting unit configured to generate a carrier phase prediction value at the second point in time on the basis of the measurement data at the first point in time and the Doppler prediction value.

The Doppler prediction unit may include: a Doppler calculating unit configured to calculate the Doppler frequency corresponding to the first point in time and a Doppler frequency corresponding to the second point in time on the basis of the navigation data; a Doppler offset determining unit configured to determine a Doppler offset corresponding to a difference between the Doppler frequency of the measurement data and the calculated Doppler frequency corresponding to the first point in time; and a Doppler prediction data generating unit configured to generate the Doppler prediction value on the basis of the Doppler offset and the Doppler frequency corresponding to the second point in time.

The carrier phase predicting unit may accumulate carrier increment values by a total number of samples to be generated in an overall prediction time duration to calculate a final phase value in the overall prediction time duration, and add the final phase value and the carrier phase value included in the measurement data at the first point in time to generate the carrier phase prediction value.

The carrier increment value may include a carrier increment value at the first point in time calculated on the basis of the Doppler frequency of the measurement data obtained at the first point in time and a carrier increment value at the second point in time calculated on the basis of the calculated Doppler frequency at the second point in time.

The apparatus may further include: a spoofing signal prediction verifying unit configured to verify the predicted characteristics of the spoofing signal. When the predicted characteristics of the spoofing signal is verified, the anti-spoofing signal generating unit generates the anti-spoofing signal on the basis of characteristics of a spoofing signal predicted with respect to a third point in time coming after the second point in time.

When the difference value between the carrier phase value measured with respect to the received spoofing signal at the second point in time and the carrier phase prediction value at the second point in time is smaller than a pre-set allowable threshold value, the spoofing signal prediction verifying unit may verify that the predicted characteristics of the spoofing signal have been normally predicted.

### BRIEF DESCRIPTION OF THE DRAWINGS

FIG. 1 is a view illustrating a phase difference between a point in time at which a spoofing signal is processed and a point in time at which an anti-spoofing signal is generated.

FIG. 2 is a view illustrating a structure of a spoofing signal predicting apparatus according to an exemplary embodiment of the present disclosure.

FIG. 3 is a view illustrating a structure of a spoofing signal reception processing unit of the spoofing signal predicting apparatus according to an exemplary embodiment of the present disclosure.

FIG. 4 is a view illustrating a structure of a spoofing signal predicting unit of the spoofing signal predicting apparatus according to an exemplary embodiment of the present disclosure.

FIG. 5 is a view illustrating a structure of a Doppler predicting unit of the spoofing signal predicting unit according to an exemplary embodiment of the present disclosure.

FIG. 6 is a flowchart illustrating a method for predicting a spoofing signal according to an exemplary embodiment of the present disclosure.

FIG. 7 is a flowchart illustrating a process of predicting a carrier phase in the method for predicting a spoofing signal according to an exemplary embodiment of the present disclosure.

FIG. 8 is a view illustrating a relationship between a point in time at which a spoofing signal is measured and a point in time at which an anti-spoofing signal is generated.

FIG. 9 is a view illustrating a process of predicting a carrier phase by a carrier phase predicting unit according to an exemplary embodiment of the present disclosure.

FIG. 10 is a flowchart illustrating a verification and anti-spoofing signal generation process in the method for predicting a spoofing signal according to an exemplary embodiment of the present disclosure.

### DETAILED DESCRIPTION OF THE EMBODIMENTS

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure.

Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

Hereinafter, a method for predicting a spoofing signal and an apparatus thereof according to exemplary embodiments of the present disclosure will be described.

In a global navigation satellite system (GNSS), an anti-spoofing signal is generated to remove a spoofing signal providing false information to a global navigation satellite apparatus, and here, there is a difference between a point in time at which the spoofing signal is processed and pertinent information is drawn and a point in time at which an anti-spoofing signal is generated by using the corresponding information.

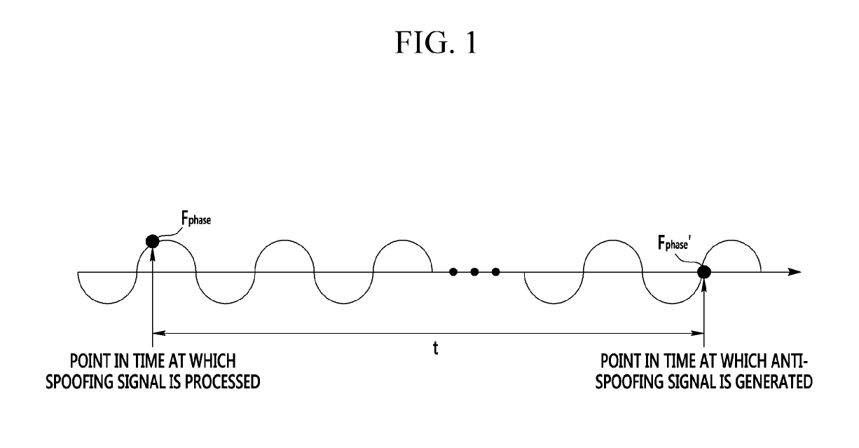

FIG. 1 is a view illustrating a phase difference between a point in time at which a spoofing signal is processed and a point in time at which an anti-spoofing signal is generated.

A point in time at which a spoofing signal is process to obtain information is a past point in time, ahead of the point in time at which an anti-spoofing signal is generated, and as illustrated in FIG. 1, carrier phase information of the signal is changed over time. Thus, characteristics of the spoofing signal at a point in time at which a future anti-spoofing signal is to be generated should be accurately predicted on the basis of phase information Fₚₕₐₛₑ of the carrier obtained at a point in which at which the spoofing signal was processed. If prediction is not accurately made, a generated anti-spoofing signal may act as another contaminated signal source to a reception apparatus. Thus, in an exemplary embodiment of the present disclosure, when the characteristics of the spoofing signal are predicted, a carrier phase is accurately predicted.

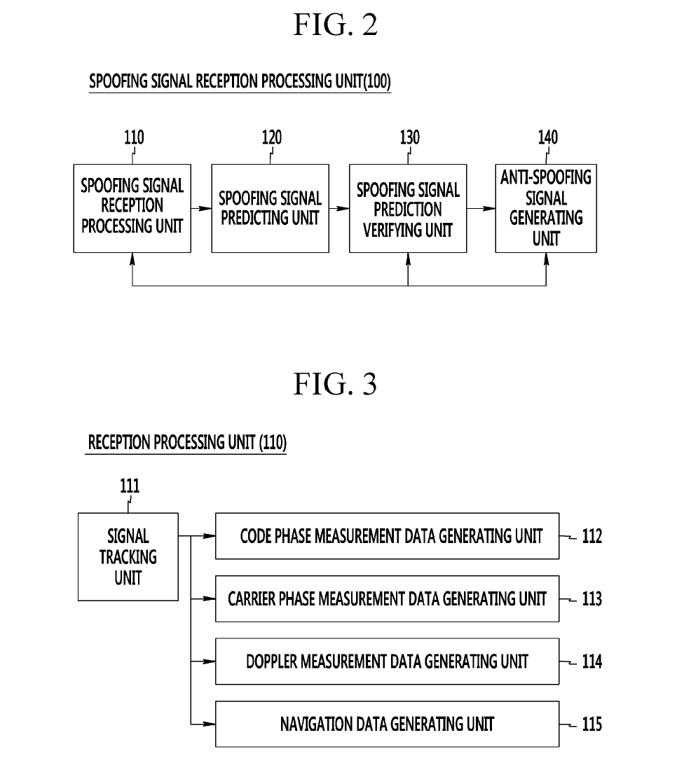

FIG. 2 is a view illustrating a structure of a spoofing signal predicting apparatus according to an exemplary embodiment of the present disclosure.

As illustrated in FIG. 2, a spoofing signal predicting apparatus 100 includes a spoofing signal reception processing unit 110, a spoofing signal predicting unit 120, a spoofing signal prediction verifying unit 130, and an anti-spoofing signal generating unit 140.

The spoofing signal reception processing unit 110 detects a spoofing signal from a reception signal, receives the detected spoofing signal, detects the received spoofing signal, and processes a signal corresponding to a spoofed pseudo random noise (PRN) signal to generate navigation data and measurement data.

The spoofing signal predicting unit 120 predicts characteristics of the spoofing signal at a point at which an anti-spoofing signal is to be generated by using the navigation data and the measurement data generated by the spoofing signal reception processing unit 110. Here, the predicted characteristics of the spoofing signal, i.e., a prediction value, includes a carrier phase, and further includes a code phase.

The spoofing signal prediction verifying unit 130 verifies whether the prediction value corresponding to the characteristics of the spoofing signal predicted by the spoofing signal predicting unit 120 is valid. In particular, the spoofing signal prediction verifying unit 130 verifies whether the predicted value of a carrier phase is valid.

When the predicted value of the spoofing signal is determined to be valid according to the verification result, the anti-spoofing signal generating unit 140 generates an anti-spoofing signal for removing the spoofing signal.

Detailed structures of the respective units 110 to 140 included in the spoofing signal predicting apparatus 100 having the foregoing configuration will now be described.

FIG. 3 is a view illustrating a structure of the spoofing signal reception processing unit of the spoofing signal predicting apparatus according to an exemplary embodiment of the present disclosure.

The spoofing signal reception processing unit 110 includes a signal tracking unit 111, a code phase measurement data generating unit 112, a carrier phase measurement data generating unit 113, a Doppler measurement data generating unit 114, and a navigation data generating unit 115.

The signal tracking unit 111 tracks the spoofing signal detected from the reception signal to generate a measurement value related to a code and a carrier, and generates bit information.

The code phase measurement data generating unit 112 may perform code tracking on the measurement value provided from the signal tracking unit 111 to generate a code phase value corresponding to the point in time at which the spoofing signal was measured.

The carrier phase measurement data generating unit 113 processes the measurement value provided from the signal tracking unit 111 to generate a carrier phase value corresponding to the point in time at which the spoofing signal was measured.

The Doppler measurement data generating unit 114 performs a frequency tracking loop on the basis of a signal output from the signal tracking unit 111 to generate a Doppler frequency value.

The navigation data generating unit 115 generates navigation data by using bit information provided from the signal tracking unit 111. The navigation data is navigation frame data including satellite ephemeris information.

The measurement data output from the spoofing signal reception processing unit 110 having the foregoing structure includes code phase information including a code phase value corresponding to the point in time at which the spoofing signal was measured, carrier phase information including a carrier phase value, and Doppler frequency information including a Doppler frequency value. The navigation data also includes navigation frame data including phase ephemeris information.

Meanwhile, the spoofing signal predicting unit 120 that predicts a spoofing signal by using the measurement data and the navigation data output from the spoofing signal reception processing unit 110 has the following structure.

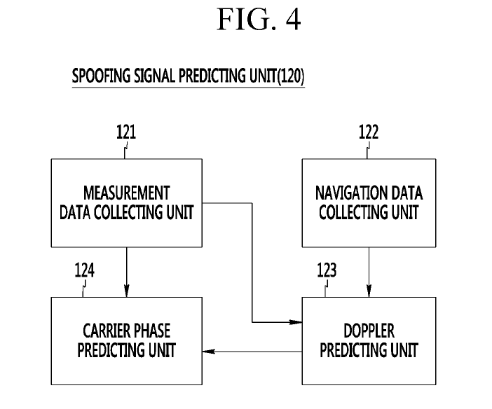

FIG. 4 is a view illustrating a structure of the spoofing signal predicting unit of the spoofing signal predicting apparatus according to an exemplary embodiment of the present disclosure.

As illustrated in FIG. 4, the spoofing signal predicting unit 120 includes a measurement data collecting unit 121, a navigation data collecting unit 122, a Doppler predicting unit 123, and a carrier phase predicting unit 124.

The measurement data collecting unit 121 collects measurement data (code phase information, carrier phase information, and Doppler frequency information) output from the spoofing signal reception processing unit 110 at a point in time at which a spoofing signal was measured.

The navigation data collecting unit 122 collects navigation data including phase ephemeris information output from the spoofing signal reception processing unit 110 at the point in time at which the spoofing signal was measured.

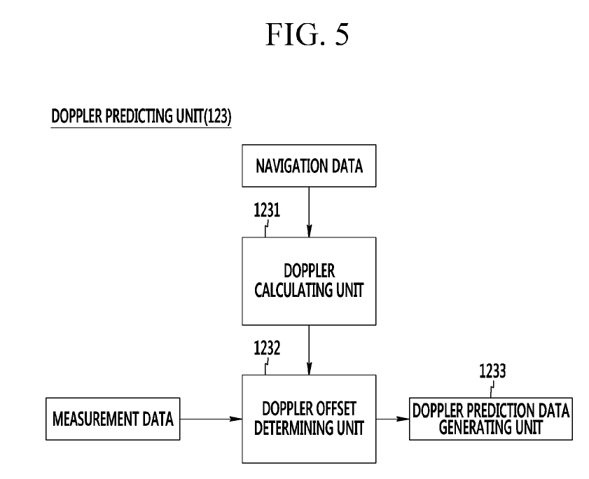

The Doppler predicting unit 123 generates a Doppler prediction value for calculating and verifying a Doppler effect at a point in time at which an anti-spoofing signal is to be generated, by using the satellite ephemeris information of the navigation data provided from the navigation data collecting unit 122. The Doppler predicting unit 123 has a structure as illustrated in FIG. 5.

FIG. 5 is a view illustrating a structure of the Doppler predicting unit of the spoofing signal predicting unit according to an exemplary embodiment of the present disclosure.

The Doppler predicting unit 123 includes a Doppler calculating unit 1231, a Doppler offset determining unit 1232, and a Doppler prediction data generating unit 1233.

The Doppler calculating unit 1231 obtains satellite ephemeris information from input navigation data (e.g., it may be provided from the navigation data collecting unit 122 of the spoofing signal predicting unit 120), calculates a location and a speed with respect to satellites corresponding to the reception signal and distances between the satellites and the reception apparatus by using the satellite ephemeris information, and calculates a Doppler frequency at a point in time at which a spoofing signal was measured and a Doppler frequency at a point in time at which an anti-spoofing signal is to be generated on the basis of the location, speed, and distance.

The Doppler offset determining unit 1232 determines a frequency offset, i.e., a Doppler offset, by comparing Doppler frequency information included in input measurement data (for example, it may be provided from the measurement data collecting unit 121 of the spoofing signal predicting unit 120) and the Doppler frequency at the point in time at which the spoofing signal was measured calculated by the Doppler calculating unit 1231.

The Doppler prediction data generating unit 1233 generates a Doppler prediction value on the basis of the Doppler offset determined by the Doppler offset determining unit 1232 and the Doppler frequency at the point in time at which the anti-spoofing signal is to be generated, which is calculated by the Doppler calculating unit 1231.

The Doppler frequency at the point in time at which the spoofing signal was measured, which is calculated on the basis of the satellite ephemeris information by the Doppler calculating unit 1231, is an ideal value which is different from a Doppler frequency measured according to a clock signal with respect to the spoofing signal received by the reception apparatus. Thus, in the exemplary embodiment of the present disclosure, a Doppler prediction value is calculated in consideration of a frequency offset with respect to the actually measured Doppler frequency and the Doppler frequency calculated as an ideal value.

Meanwhile, the carrier phase predicting unit 124 of the spoofing signal predicting unit 120 generates a carrier phase prediction value at the point time at which the anti-spoofing signal is to be generated, on the basis of the measurement data provided from the measurement data collecting unit 121 and the Doppler prediction value provided from the Doppler predicting unit 123.

The carrier phase prediction performed by the carrier wave phase predicting unit 124 and the anti-spoofing signal generation performed by the anti-spoofing signal generating unit 140 will be described in detail hereinbelow.

Hereinafter, a method for predicting a spoofing signal according to an exemplary embodiment of the present disclosure will be described on the basis of the foregoing structures.

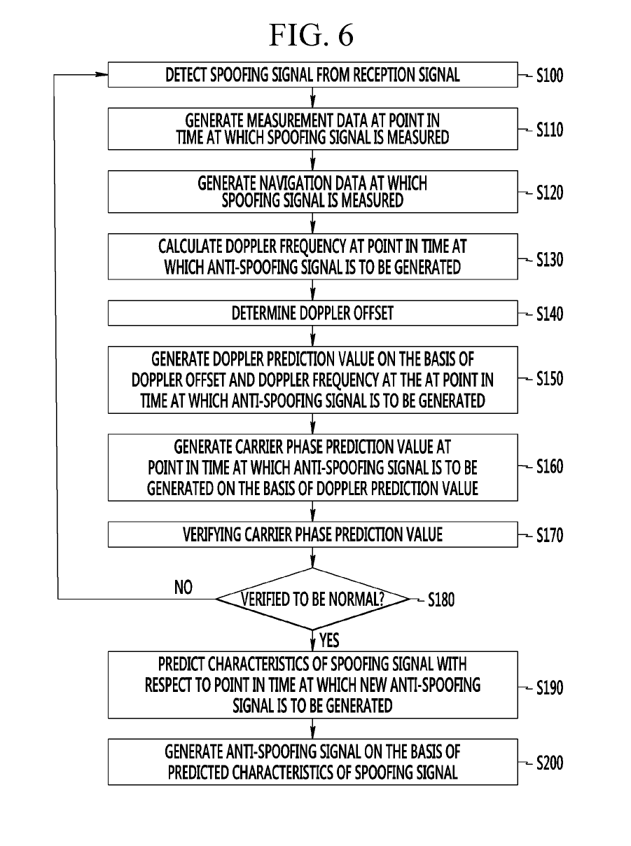

FIG. 6 is a flowchart illustrating a method for predicting a spoofing signal according to an exemplary embodiment of the present disclosure.

A spoofing signal having a structure identical to that of a signal from a satellite and including a navigation error may be transmitted from a spoofing signal source. The spoofing signal predicting apparatus 100 of a reception apparatus detects a spoofing signal from received signals (S100). For example, the spoofing signal predicting apparatus 100 may detect a spoofing signal on the basis of signal strength by using the fact that the spoofing signal is generated as a stronger signal than a satellite signal.

The spoofing signal predicting apparatus 100 traces the detected spoofing signal and generates measurement data corresponding to a point in time at which the spoofing signal was measured (S110). The measurement data includes a code phase value, a carrier phase value, and a Doppler frequency value obtained through a frequency tracking loop.

The spoofing signal predicting apparatus 100 also generates navigation data including phase ephemeris information by using bit information included in the spoofing signal (S120).

Thereafter, the spoofing signal predicting apparatus 100 calculates a location and a speed with respect to satellites corresponding to reception signals, as well as distances between satellites and the reception apparatus, and calculates a Doppler frequency at a point in time at which the spoofing signal was measured and a Doppler frequency at a point in which at which an anti-spoofing signal is to be generated (S130).

The spoofing signal predicting apparatus 100 determines a frequency offset, i.e., a Doppler offset, by comparing the Doppler frequency information included in the measurement data obtained at the point in time at which the spoofing signal was measured and the calculated Doppler frequency (S140). The spoofing signal predicting apparatus 100 generates a Doppler prediction value on the basis of the Doppler offset and the Doppler frequency at the point in time at which the anti-spoofing signal is to be generated (S150).

Further, the spoofing signal predicting apparatus 100 generates a carrier phase prediction value at the point in time at which the anti-spoofing signal is to be generated, on the basis of the measurement data obtained at the point in time at which the spoofing signal was measured and the Doppler prediction value.

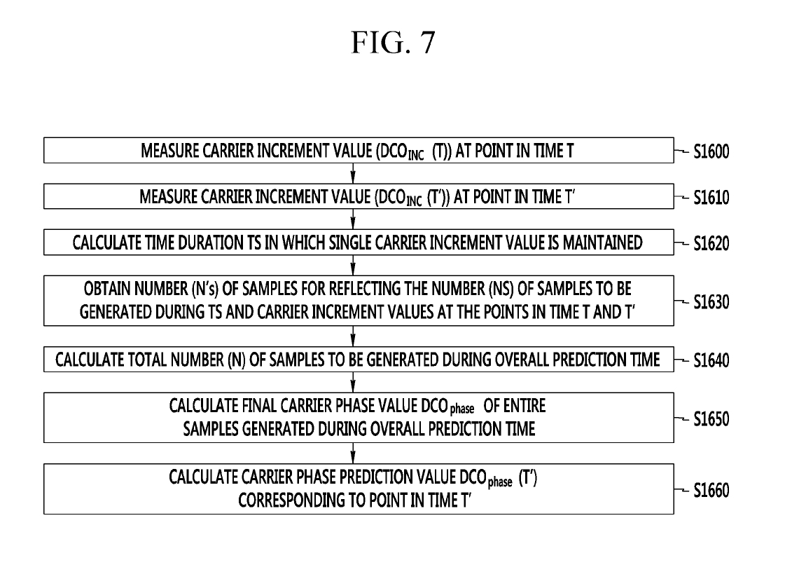

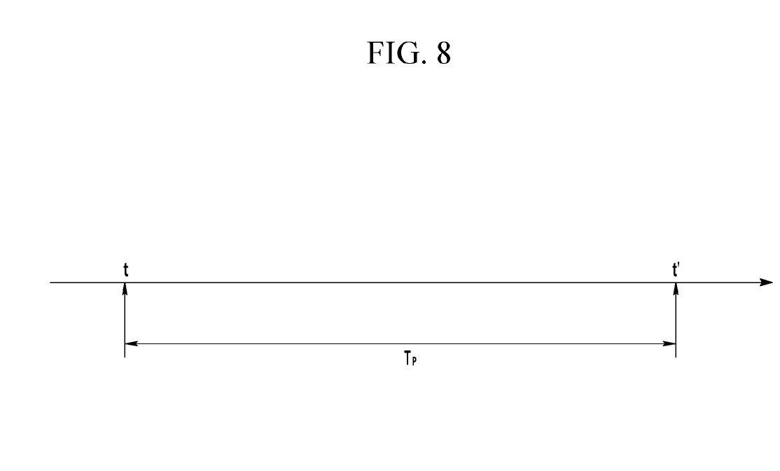

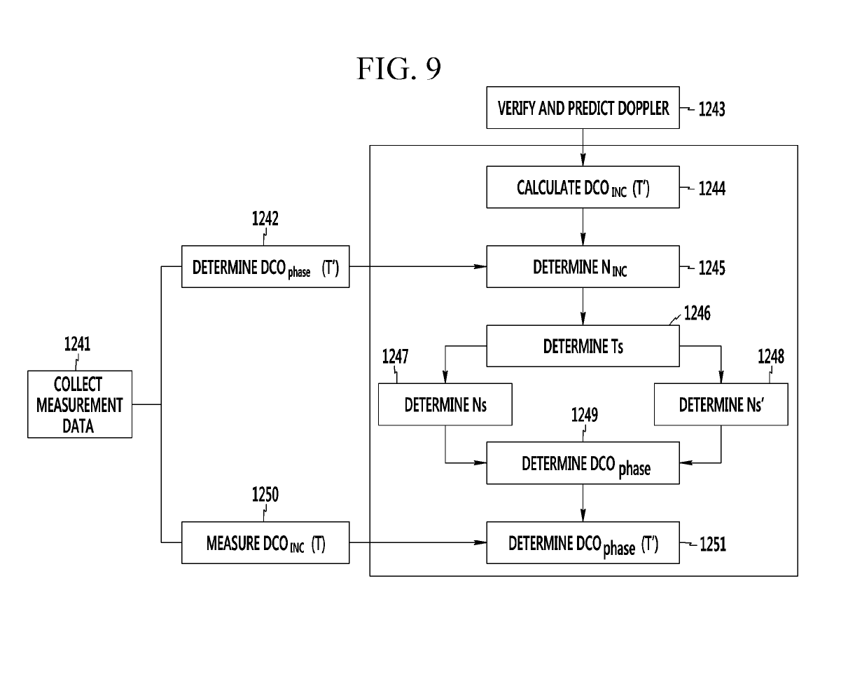

FIG. 7 is a flowchart illustrating a process of predicting a carrier phase in the method for predicting a spoofing signal according to an exemplary embodiment of the present disclosure. FIG. 8 is a view illustrating a relationship between a point in time at which a spoofing signal is measured and a point in time at which an anti-spoofing signal is generated. FIG. 9 is a view illustrating a process of predicting a carrier phase by a carrier phase predicting unit according to an exemplary embodiment of the present disclosure.

As illustrated in FIGS. 7 through 9, the spoofing signal predicting apparatus 100 processes a spoofing signal at a point in time t to obtain measurement data and navigation data, and generates an anti-spoofing signal at a point of time t′ by using the spoofing signal processing results. In FIG. 8, indicates a prediction time duration from the point in time t to the point in time t′.

The spoofing signal predicting apparatus 100 predicts characteristics of the spoofing signal at the point in time t′ at which a future anti-spoofing signal is to be generated by using the time information of the point in time t at which the spoofing signal was measured, and generates an anti-spoofing signal by using the predicted information.

The spoofing signal predicting apparatus 100 measures a carrier increment value DCO_{INC}(t) at the point in time t on the basis of Doppler frequency information measured by performing frequency tracking at the point in time t (S1600) (1241 and 1242 in FIG. 9). In this case, the spoofing signal predicting apparatus 100 may calculate the carrier increment value as expressed in Equation 1 by using the Doppler frequency D_{f}(t) measured by processing the spoofing signal.

$${DCO}_{INC} ( t ) = \frac{{C}_{f} + {D}_{f} ( t )}{{S}_{f}} \times {2}^{N} \qquad ( Equation 1 )$$

Here, C_{f} is a central frequency of a carrier, S_{f} is a sampling frequency, and 2^{N} is a size of a carrier digitally controlled oscillator (DCO).

Next, the spoofing signal predicting apparatus 100 calculates a carrier increment value DCO_{INC}(t′) at the point in time t′ after the lapse of the time duration T_{P} used to predict the characteristics of the spoofing signal from the point in time t at which the spoofing signal was measured (S1610). In detail, the spoofing signal predicting apparatus 100 calculates a carrier increment value DCO_{INC}(t′) at the point in time t′ by using the carrier increment value DCO_{INC}(t) at the point in time t and the Doppler frequency at the point in time at which the anti-spoofing signal is to be generated as calculated in operation S130, i.e., the Doppler frequency at the point in time t′, as expressed in Equation 1 below (1243 and 1244 in FIG. 9).

$${DCO}_{INC} ( {t}^{′} ) = \frac{{C}_{f} + {D}_{f} ( {t}^{′} )}{{S}_{f}} \times {2}^{N} \qquad ( Equation 2 )$$

Next, the spoofing signal predicting apparatus 100 calculates a difference N_{INC} between the carrier increment values by using the carrier increment value DCO_{INC}(t) at the point in time t and the carrier increment value DCO_{INC}(t′) e at the point in time t′ on the basis of Equation 3 below (1245 in FIG. 9).

N_{INC}=DCO_{INC}(t′)−DCO_{INC}(t) (Equation 3)

DCO_{INC}(t) and DCO_{INC}(t′) may be determined as integer values between 0 and 2^{N}, and the difference between the two values may also be determined as an integer value. Thus, the difference value N_{INC} between the carrier increment values may be equal to a variation in the carrier increment values in the time duration T_{P} from the point in time t.

On the basis of this, a time duration Tₛ in which the carrier increment values are reflected at the same time interval is determined (S1620).

Since a time at which the carrier increment value DCO_{INC}(t) measured at the point in time t is to be reflected in a sample and a time at which the carrier increment value DCO_{INC}(t′) calculated at the point in time t′ is to be reflected in the sample cannot be accurately known, the time duration Tₛ in which a single carrier increment value is maintained may be calculated by dividing a value (N_{INC}−2) obtained by excluding the number of changes in the carrier increment values at the points in time t and t′ from the variation N_{INC} of the total increment value in the overall prediction time duration, by the overall prediction time duration T_{P}, as expressed by Equation 4 below (1246 in FIG. 9).

$${T}_{s} = \frac{{T}_{p}}{{N}_{INC} - 2} \qquad ( Equation 4 )$$

Here, the number of changes in the carrier increment values is 2 on the basis of DCO_{INC}(t) and DCO_{INC}(t′).

When a time duration in which a single carrier increment value is uniformly reflected, that is, the sample reflection time duration Tₛ, is calculated, the spoofing signal predicting apparatus 100 may calculate the number of samples N_{S} to be generated in the sample reflection time duration Tₛ as follows (1247 in FIG. 9).

N_{S}=Tₛ×S_{f} (Equation 5)

The spoofing signal predicting apparatus 100 calculates the number of samples N_{S}′ for reflecting the carrier increment values at the points in time t and t′ as follows (1248 in FIG. 9).

N_{S}′=(T_{P}−(N_{INC}−2)×T_{S})×S_{f} (Equation 6)

The number of samples N_{S}′ may be indicated as the number of samples to be generated during a time ((T_{P}−(N_{INC}−2)×T_{S})) obtained by subtracting a time for generation at the interval of the sample reflection time duration Tₛ from the overall prediction time duration T_{P} as expressed by Equation 6 above (S1630).

Thus, the total number of samples N to be generated in the total prediction time duration T_{P} is calculated as follows (S1640).

$$N = {\sum }_{i = 1}^{n - 1} {N}_{S} + {N}_{S}^{′} \qquad ( Equation 7 )$$

Thereafter, the spoofing signal predicting apparatus 100 determines a final phase by accumulating the carrier increment values at every number of samples in which the carrier increment values are to be reflected. That is, when the carrier increment values are accumulated at every sample number, a final phase value DCO_{Phase} of all samples generated in the overall prediction time duration T_{P} is as expressed by Equation 8 below (1249 in FIG. 9).

$${DCO}_{Phase} = {\sum }_{i = 1}^{n - 1} {DCO}_{INC} ( t + i ) \times {N}_{S} + ( {DCO}_{INC} ( t ) + {DCO}_{INC} ( t + n ) ) \times {N}_{S} \qquad ( Equation 8 )$$

The final phase value DCO_{Phase}of the calculated samples is a final DCO value of each sample in which the carrier increment values are accumulated. Thus, when ANDing is performed with the DCO size (2^{N}), a substantial carrier phase value having an integer value between 0 to 2^{N} is obtained (S1650).

DCO_{Phase}=DCO_{Phase} & 2^{N} (Equation 9)

In this manner, after the final carrier phase value DCO_{Phase} of each sample is calculated, a carrier phase prediction value DCO_{Phase}(t′) corresponding to the point in time t′ at which the anti-spoofing signal is to be generated (S1660). The carrier phase prediction value DCO_{Phase}(t′) may be calculated by adding the carrier phase value DCO_{Phase} changed in the overall prediction time duration T_{P} and the carrier phase value DCO_{Phase}(t) at the point in time t (1250 and 1251 in FIG. 9).

DCO_{Phase}(t′)=(DCO_{Phase}+DCO_{Phase}(t)) (Equation 10)

As described above, the spoofing signal predicting apparatus 100 generates carrier phase prediction values at the point in time at which the anti-spoofing signal is to be generated on the basis of the measurement data and the Doppler prediction value obtained at the point in time at which the spoofing signal was measured, and subsequently verifies the prediction values as illustrated in FIG. 6 (S170).

The spoofing signal predicting apparatus 100 verifies the carrier phase prediction values as the characteristics of the spoofing signal predicted with respect to the point in time t′ at which the anti-spoofing signal is to be generated by using the navigation data and measurement data obtained by processing the spoofing signal. For verification, the spoofing signal predicting apparatus 100 obtains the measurement data by processing the spoofing signal actually received by the reception apparatus at the point in time t′ at which the anti-spoofing signal is to be generated, and compares the measurement data at the point in time t′ at which the anti-spoofing signal is to be generated and the prediction data predicted with respect to the point in time t′ at which the anti-spoofing signal is to be generated obtained through the foregoing prediction process.

In detail, the spoofing signal predicting apparatus 100 compares the carrier phase value actually measured at the point in time t′ at which the anti-spoofing signal is to be generated and the predicted carrier phase value, and when it is verified that the prediction has been normally made (S180), the spoofing signal predicting apparatus 100 newly predicts signal characteristics of a spoofing signal corresponding to a point in time at which an anti-spoofing signal is to be actually generated (S190). That is, the point in time t′ at which the anti-spoofing signal is to be generated is a past point in time through the foregoing verification process. Thus, when the data predicted with respect to the point in time t′ at which the anti-spoofing signal is to be generated are verified to be valid, the spoofing signal predicting apparatus 100 predicts characteristics of a spoofing signal corresponding to a point in time t″ at which a future new anti-spoofing signal is to be generated, on the basis of the foregoing prediction process, to generate a prediction value (a carrier phase value, a code phase value, or the like).

The spoofing signal predicting apparatus 100 generates an anti-spoofing signal on the basis of the generated prediction values at the point in time t″ at which an anti-spoofing signal is to be generated (S200).

Meanwhile, when the prediction value at the point in time t′ at which the anti-spoofing signal is to be generated is determined to be invalid, the spoofing signal predicting apparatus 100 again performs the operation to process a received spoofing signal to generate measurement data and predict characteristics of a spoofing signal for generating an anti-spoofing signal on the basis of the generated measurement data.

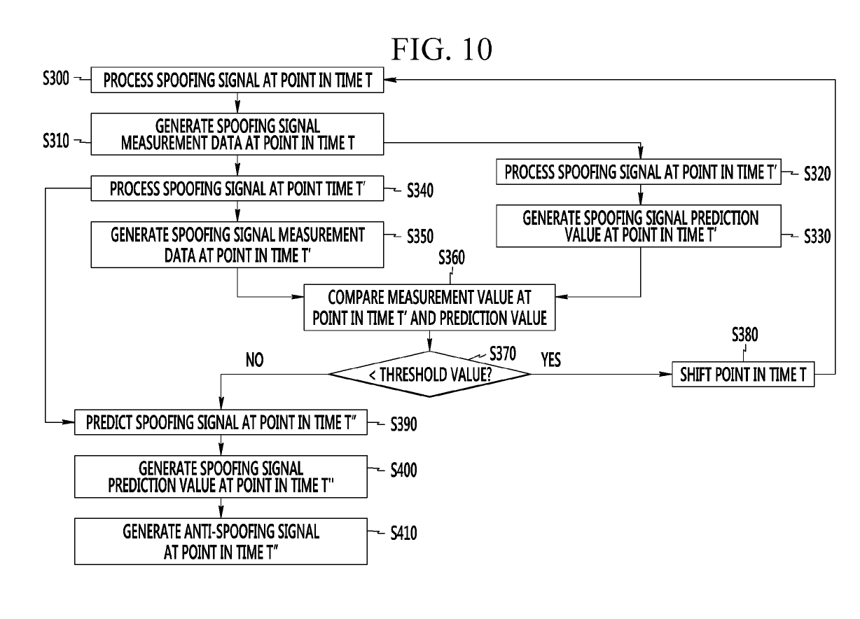

FIG. 10 is a flowchart illustrating a verification and anti-spoofing signal generation process in the method for predicting a spoofing signal according to an exemplary embodiment of the present disclosure.

As described above, after generating a spoofing signal prediction value (a carrier phase prediction value, or the like) by predicting characteristics of a spoofing signal at a point in time t′ at which an anti-spoofing signal is to be generated on the basis of the measurement data and the navigation data obtained by processing a spoofing signal at a point in time t at which the spoofing signal was measured (S300 to S330), the spoofing signal predicting apparatus 100 generates measurement data and navigation data by processing a spoofing signal actually received at the point in time t′ at which an anti-spoofing signal is to be generated (S340 and S350). For the purposes of description, the measurement data and the navigation data obtained at the point in time t at which the spoofing signal was measured may be called measurement data and navigation data at a first measurement point in time, and the measurement data and the navigation data obtained at the point in time t′ at which the anti-spoofing signal was measured may be called measurement data and navigation data at a second measurement point in time.

The spoofing signal predicting apparatus 100 compares the measurement data (in particular, a carrier phase value) at the second measurement point in time with the spoofing signal prediction value (in particular, a carrier phase prediction value) predicted with respect to the point in time t′ at which the anti-spoofing signal is to be generated, to determine whether a difference value therebetween is smaller than a pre-set allowable threshold value (S360 and S370). When the difference value is greater than the allowable threshold value, the spoofing signal predicting apparatus 100 determines that the spoofing signal characteristics prediction has not been normally made, shifts the point in time t, and newly performs spoofing signal measurement and prediction (S380).

Meanwhile, when the difference value between the two values is smaller than the allowable threshold value, the spoofing signal predicting apparatus 100 determines that the spoofing signal characteristics prediction has been normally made, and predicts characteristics of a spoofing signal with respect to a point in time t″ at which a new anti-spoofing signal is to be generated by using the spoofing signal measurement data and navigation data at the point in time t′ to generate a new spoofing signal prediction value (a carrier phase prediction value, or the like) (S390 and S400). The spoofing signal predicting apparatus 100 generates an anti-spoofing signal at the point in time t″ by using the spoofing signal prediction value generated with respect to the point in time t″ at which a new anti-spoofing signal is to be generated (S410).

According to exemplary embodiments of the present disclosure, in generating an anti-spoofing signal to cope with an influence of a spoofing signal source in a navigation satellite system, characteristics of a spoofing signal can be recognized and a characteristic parameter of the spoofing signal can be accurately predicted.

Thus, the characteristics of a spoofing signal corresponding to a future point in time at which an anti-spoofing signal is generated can be accurately predicted, and by generating an accurate anti-spoofing signal on the basis of the predicted spoofing signal, the spoofing signal can be effectively canceled.

The embodiments of the present disclosure may not necessarily be implemented only through the foregoing apparatuses and/or methods, but may also be implemented through a program for realizing functions corresponding to the configurations of the embodiments of the present disclosure, a recording medium including the program, or the like, and such an implementation may be easily made by a skilled person in the art to which the present disclosure pertains from the foregoing description of the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for predicting a spoofing signal, the method comprising:
generating measurement data including a carrier phase value of a spoofing signal at a first point in time;
predicting characteristics of a spoofing signal corresponding to a second point in time at which an anti-spoofing signal is to be generated, on the basis of the measurement data at the first point in time, the characteristics including a carrier phase prediction value; and
generating an anti-spoofing signal on the basis of the predicted characteristics of the spoofing signal,
wherein the second point in time comes after the first point in time.

2. The method of claim 1, further comprising
verifying the predicted characteristics of the spoofing signal,
wherein, in the generating of the anti-spoofing signal, the anti-spoofing signal is generated after the predicted characteristics of the spoofing signal are verified.

3. The method of claim 1, wherein
the verifying comprises:
obtaining measurement data including a carrier phase value with respect to the spoofing signal received at the second point in time;
obtaining a difference value between the carrier phase prediction value at the second point in time and the carrier phase value at the second point in time; and
when the difference value is smaller than a pre-set allowable threshold value, verifying that the predicted characteristics of the spoofing signal have been normally predicted.

4. The method of claim 3, wherein
the generating of the anti-spoofing signal comprises:
when the difference value is smaller than the pre-set allowable threshold value, predicting characteristics of the spoofing signal corresponding to a third point in time on the basis of the measurement data at the second point in time; and
generating an anti-spoofing signal on the basis of the predicted characteristics of the spoofing signal at the third point in time,
wherein the third point in time comes after the second point in time.

5. The method of claim 1, wherein
the measurement data further comprises a Doppler frequency with respect to the spoofing signal, and
the predicting comprises:
generating a Doppler prediction value corresponding to the second point in time on the basis of the Doppler frequency of the measurement data; and
generating a carrier phase prediction value at the second point in time on the basis of the measurement data at the first point in time and the Doppler prediction value.

6. The method of claim 5, further comprising
obtaining navigation data including satellite ephemeris information from the spoofing signal at the first point in time,
wherein the generating of the Doppler prediction value comprises:
calculating a Doppler frequency at the first point in time and a Doppler frequency at the second point in time on the basis of the navigation data, respectively;
determining a Doppler offset on the basis of the calculated Doppler frequency at the first point in time and the Doppler frequency of the measurement data obtained at the first point in time; and
generating a Doppler prediction value corresponding to the second point in time on the basis of the Doppler offset and the calculated Doppler frequency at the second point in time.

7. The method of claim 6, wherein
the generating of the carrier phase prediction value comprises:
calculating a total number of samples to be generated in an overall prediction time duration;
accumulating carrier increment values at sample reflection time intervals by the total number of samples to calculate a final phase value in the overall prediction time duration; and
adding the final phase value and the carrier phase value included in the measurement data at the first point in time to generate the carrier phase prediction value.

8. The method of claim 7, wherein the carrier increment value comprises a carrier increment value at the first point in time calculated on the basis of the Doppler frequency of the measurement data obtained at the first point in time and a carrier increment value at the second point in time calculated on the basis of the calculated Doppler frequency at the second point in time.

9. The method of claim 8, wherein
the calculating of the total number of samples comprises:
calculating a sample reflection time duration in which a single carrier increment value is maintained; and
calculating the total number of samples on the basis of the number of samples to be reflected in the sample reflection time duration and the number of samples for reflecting the carrier increment values at the first and second points in time.

10. An apparatus for predicting a spoofing signal in a navigation system, the apparatus comprising:
a spoofing signal reception processing unit configured to detect a spoofing signal from a received signal, and generate measurement data including a carrier phase value of the spoofing signal at a first point in time;
a spoofing signal predicting unit configured to predict characteristics of a spoofing signal corresponding to a second point in time at which an anti-spoofing signal is to be generated, on the basis of the measurement data at the first point in time, the characteristics including a carrier phase prediction value; and
an anti-spoofing signal generating unit configured to generate an anti-spoofing signal on the basis of the predicted characteristics of the spoofing signal.

11. The apparatus of claim 10, wherein
the spoofing signal reception processing unit comprises:
a signal tracking unit configured to trace the detected spoofing signal to generate measurement values related to a code and a carrier, and generate bit information;
a code phase measurement data generating unit configured to perform code tracking on the measurement values to generate a code phase value corresponding to the first point in time;
a carrier phase measurement data generating unit configured to process the measurement values to generate a carrier phase value corresponding to the first point in time;
a Doppler measurement data generating unit configured to perform a frequency tracking loop on the basis of a signal output from the signal tracking unit to generate a Doppler frequency corresponding to the first point in time; and
a navigation data generating unit configured to generate navigation data including satellite ephemeris information on the basis of the bit information.

12. The apparatus of claim 11, wherein the
the spoofing signal predicting unit comprises:
a measurement data collecting unit configured to collect measurement data including the code phase value, the carrier phase value, and the Doppler frequency corresponding to the first point in time output from the spoofing signal reception processing unit;
a navigation data collecting unit configured to collect navigation data output from the spoofing signal reception processing unit;
a Doppler predicting unit configured to generate a Doppler prediction value corresponding to the second point in time on the basis of the Doppler frequency of the measurement data; and
a carrier phase predicting unit configured to generate a carrier phase prediction value at the second point in time on the basis of the measurement data at the first point in time and the Doppler prediction value.

13. The apparatus of claim 12, wherein
the Doppler prediction unit comprises:
a Doppler calculating unit configured to calculate the Doppler frequency corresponding to the first point in time and a Doppler frequency corresponding to the second point in time on the basis of the navigation data;
a Doppler offset determining unit configured to determine a Doppler offset corresponding to a difference between the Doppler frequency of the measurement data and the calculated Doppler frequency corresponding to the first point in time; and
a Doppler prediction data generating unit configured to generate the Doppler prediction value on the basis of the Doppler offset and the Doppler frequency corresponding to the second point in time.

14. The apparatus of claim 13, wherein the carrier phase predicting unit accumulates carrier increment values by a total number of samples to be generated in an overall prediction time duration to calculate a final phase value in the overall prediction time duration, and adds the final phase value and the carrier phase value included in the measurement data at the first point in time to generate the carrier phase prediction value.

15. The apparatus of claim 14, wherein the carrier increment value comprises a carrier increment value at the first point in time calculated on the basis of the Doppler frequency of the measurement data obtained at the first point in time and a carrier increment value at the second point in time calculated on the basis of the calculated Doppler frequency at the second point in time.

16. The apparatus of claim 10, further comprising
a spoofing signal prediction verifying unit configured to verify the predicted characteristics of the spoofing signal,
wherein when the predicted characteristics of the spoofing signal is verified, the anti-spoofing signal generating unit generates the anti-spoofing signal on the basis of characteristics of a spoofing signal predicted with respect to a third point in time coming after the second point in time.

17. The apparatus of claim 16, wherein when the difference value between the carrier phase value measured with respect to the received spoofing signal at the second point in time and the carrier phase prediction value at the second point in time is smaller than a pre-set allowable threshold value, the spoofing signal prediction verifying unit verifies that the predicted characteristics of the spoofing signal have been normally predicted.
